(19) United States
(12) Patent Application Publication
(10) Pub. No.: US 2026/0073910 A1
(43) Pub. Date: Mar. 12, 2026

(54) JOINT SPEECH TEXT TRAINING FOR HYBRID TRANSDUCER AND ATTENTION-BASED ENCODER-DECODER MODELING

(71) Applicant: Samsung Electronics Co., Ltd., Suwon-si (KR)

(72) Inventors: Yun Tang, Fremont, CA (US); Euisung Kim, Mountain View, CA (US); Taeyeon Ki, San Jose, CA (US); Vijendra Raj Apsingekar, San Jose, CA (US)

(21) Appl. No.: 19/296,661

(22) Filed: Aug. 11, 2025

Related U.S. Application Data
(60) Provisional application No. 63/691,946, filed on Sep. 6, 2024.

(51) Int. Cl. G10L 15/08; G10L 15/06

(52) U.S. Cl. CPC G10L 15/083; G10L 15/063

(57) ABSTRACT

A method includes generating speech embeddings corresponding to a received speech input using a speech encoder. The method also includes generating multi-modal embeddings corresponding to the received speech input using a shared encoder. The method further includes generating conditioned multi-modal embeddings corresponding to the received speech input using a predictor. In addition, the method includes generating a text prediction corresponding to the received speech input based on the multi-modal embeddings and the conditioned multi-modal embeddings using a joint network.

### CROSS-REFERENCE TO RELATED APPLICATION AND PRIORITY CLAIM

This application claims priority under 35 U.S.C. § 119 (e) to U.S. Provisional Patent Application No. 63/691,946 filed on Sep. 6, 2024, which is hereby incorporated by reference in its entirety.

### TECHNICAL FIELD

This disclosure relates generally to speech processing systems and methods. More specifically, this disclosure relates to joint speech text training for hybrid transducer and attention-based encoder-decoder modeling.

### BACKGROUND

Conventional automatic speech recognition (ASR) systems are built around separate dedicated models to represent acoustic and linguistic information. An acoustic model can be trained with a human speech data corpus, while a language model can be trained with an abundant text corpus. The amount of text in the text corpus may be several orders of magnitude larger than the amount of text in the speech corpus. An end-to-end based modeling approach integrates both representations in one model. However, the model has to be trained with a speech corpus only, which leads to inferior modeling capabilities for the linguistic information.

### SUMMARY

This disclosure relates to joint speech text training for hybrid transducer and attention-based encoder-decoder modeling.

In a first embodiment, a method includes generating speech embeddings corresponding to a received speech input using a speech encoder. The method also includes generating multi-modal embeddings corresponding to the received speech input using a shared encoder. The method further includes generating conditioned multi-modal embeddings corresponding to the received speech input using a predictor. In addition, the method includes generating a text prediction corresponding to the received speech input based on the multi-modal embeddings and the conditioned multi-modal embeddings using a joint network.

In a second embodiment, an electronic device includes at least one processing device configured to generate speech embeddings corresponding to a received speech input using a speech encoder. The at least one processing device is also configured to generate multi-modal embeddings corresponding to the received speech input using a shared encoder. The at least one processing device is further configured to generate conditioned multi-modal embeddings corresponding to the received speech input using a predictor. In addition, the at least one processing device is configured to generate a text prediction corresponding to the received speech input based on the multi-modal embeddings and the conditioned multi-modal embeddings using a joint network.

In a third embodiment, a non-transitory machine readable medium contains instructions that when executed cause at least one processor of an electronic device to generate speech embeddings corresponding to a received speech input using a speech encoder. The instructions when executed also cause the at least one processor to generate multi-modal embeddings corresponding to the received speech input using a shared encoder. The instructions when executed further cause the at least one processor to generate conditioned multi-modal embeddings corresponding to the received speech input using a predictor. In addition, the instructions when executed cause the at least one processor to generate a text prediction corresponding to the received speech input based on the multi-modal embeddings and the conditioned multi-modal embeddings using a joint network.

Any single one or any combination of the following features may be used with the first, second, or third embodiment. The text prediction may be generated by a machine learning model. The machine learning model may be trained using a loss function, and the loss function may include a transducer loss from the joint network and an attention-based encoder-decoder loss from the predictor. The machine learning model may be trained to perform in a first domain and may be adapted to perform in a second domain by training the predictor using a training dataset with text data and no speech data. The machine learning model may be trained to perform in the first domain by training the predictor using a training dataset with speech data and text data. The machine learning model may include a hybrid transducer and attention-based encoder-decoder. The speech encoder may include conformer layers, the shared encoder may include transformer layers, and self-attention with relative position embedding may be used in both the conformer layers and the transformer layers.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration within which a hybrid transducer and attention-based encoder-decoder may be employed in accordance with this disclosure;

FIG. 2 illustrates an example process of training a hybrid transducer and attention-based encoder-decoder in accordance with this disclosure; and

FIG. 3 illustrates an example framework for a hybrid transducer and attention-based encoder-decoder in accordance with this disclosure.

### DETAILED DESCRIPTION

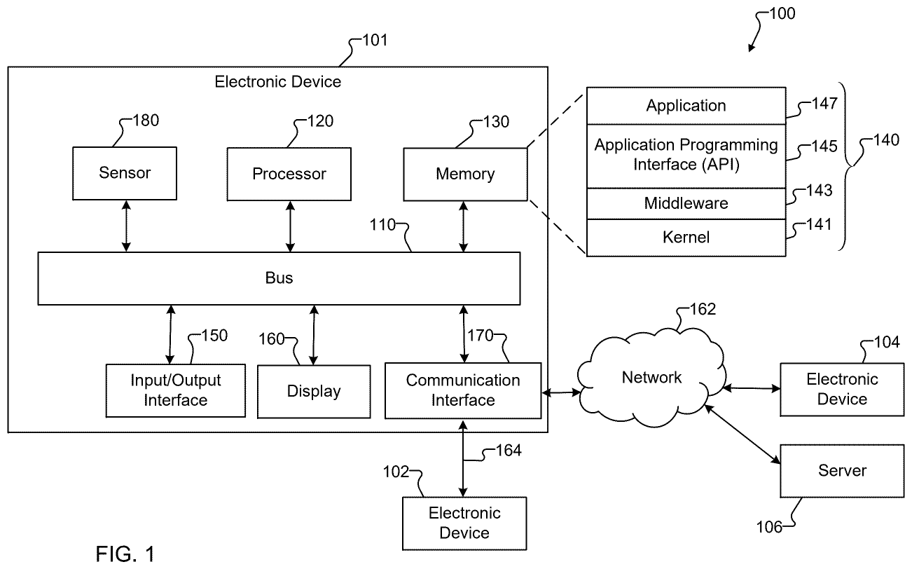

FIGS. 1 through 3, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, conventional automatic speech recognition (ASR) systems are built around separate dedicated models to represent acoustic and linguistic information. An acoustic model can be trained with a human speech data corpus, while a language model can be trained with an abundant text corpus. The amount of text in the text corpus may be several orders of magnitude larger than the amount of text in the speech corpus. An end-to-end based modeling approach integrates both representations in one model. However, the model has to be trained with a speech corpus only, which leads to inferior modeling capabilities for the linguistic information.

One challenge with end-to-end ASR modeling is the lack of an ability to integrate abundant linguistic information, and a dedicated language model is still required. Here, a model is often trained with speech data only and may not have the ability to integrate a text-only training corpus. Also, domain adaptation on an end-to-end ASR system can be based on a speech data corpus only. Since the model does not have the ability to integrate a text training corpus directly, speech data typically needs to be collected (either directly or by recording) and transcribed, which is expensive. An alternative solution is to synthesize audio from given transcripts using commercial text-to-speech systems, but the resulting synthesized audio usually introduces very strong biases that can hurt performance when processing human speech. Both approaches greatly increase the cost to adapt a general-purpose system to a specific domain or user.

This disclosure provides various techniques for joint speech text training for hybrid transducer and attention-based encoder-decoder (TAED) modeling. In this disclosure, a training corpus including both speech and corresponding text can be leveraged to build an end-to-end speech-to-text model based on a hybrid transducer and attention-based encoder-decoder framework. More specifically, a shared encoder can be trained to receive speech embeddings output by a speech encoder or a corresponding text embedding and to output multi-modal embeddings. In some cases, one of two training data modalities (speech or text) can be taken as input. Also, both modalities may be used to adapt a model to a new domain, but using only text-based transcripts or other text-based training data to adapt the model may reduce costs.

In this way, a hybrid transducer and attention-based encoder-decoder framework can be extended from speech only to a multimodality-based model that takes both speech and text as input. Joint speech and text optimization for hybrid transducer and attention-based encoder-decoder modeling can therefore be applied to automatic speech recognition. The hybrid transducer and attention-based encoder-decoder can be optimized with both speech and text input modalities jointly, even though speech data is taken as input during inferencing. In some cases, the joint training can be conducted on a multitask learning framework with two main subtasks, namely an attention-based encoder-decoder task and a transducer task. A fusion decoding strategy can leverage the decoding results from the transducer and attention-based encoder-decoder, and the jointly-trained model can be further extended for text-based domain adaptation, which can effectively alleviate data scarcity issues during domain adaptation since no speech data may be needed. The joint modality training may also effectively integrate speech and linguistic information into one model.

FIG. 1 illustrates an example network configuration 100 within which a hybrid transducer and attention-based encoder-decoder may be employed in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform various operations related to a hybrid transducer and attention-based encoder-decoder.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to a hybrid transducer and attention-based encoder-decoder. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, Wi-Fi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the server 106 may perform various operations related to a hybrid transducer and attention-based encoder-decoder.

Although FIG. 1 illustrates one example of a network configuration 100 including an electronic device 101 within which a hybrid transducer and attention-based encoder-decoder may be employed, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

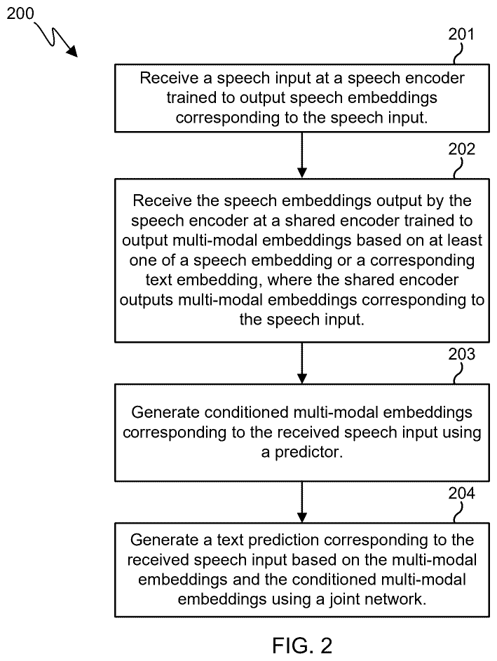

FIG. 2 illustrates an example process 200 of training a hybrid transducer and attention-based encoder-decoder in accordance with this disclosure. For ease of explanation, the process 200 of FIG. 2 is described as being performed using the electronic device 101 and/or the server 106 in the network configuration 100 of FIG. 1. However, the process 200 may be performed using any other suitable device(s) and in any other suitable system(s).

As shown in FIG. 2, the process 200 begins with generating speech embeddings corresponding to a received speech input using a speech encoder (step 201). In some embodiments, the speech encoder may be formed using conformer layers rather than transformer layers. Multi-modal embeddings corresponding to the received speech input are generated using a shared encoder (step 202). In some embodiments, the shared encoder may be formed using transformer layers. Also, in some embodiments, both the conformer layers and the transformer layers may use self-attention with relative position embedding. Conditioned multi-modal embeddings corresponding to the received speech input are generated using a predictor (step 203). In some embodiments, the conditioned multi-modal embeddings can be conditioned by the predicted based on previous text prediction outputs.

A text prediction corresponding to the received speech input is generated based on the multi-modal embeddings and the conditioned multi-modal embeddings using a joint network (step 204). In some embodiments, the text prediction may be generated by a machine learning model, which could be trained using a loss function including a transducer loss from the joint network and an attention-based encoder-decoder loss from the predictor in some cases. Also, in some embodiments, the machine learning model may be trained to perform in a first domain and adapted to perform in a second domain, such as by training the predictor using a training dataset with text data and no speech data. Here, the machine learning model may be trained to perform in the first domain by training the predictor using a training dataset with speech data and text data. In some embodiments, the machine learning model may include a hybrid transducer and attention-based encoder-decoder.

Although FIG. 2 illustrates one example of a process 200 of training a hybrid transducer and attention-based encoder-decoder, various changes may be made to FIG. 2. For example, while shown as a series of steps, various steps in FIG. 2 could overlap, occur in parallel, occur in a different order, or occur any number of times (including zero times).

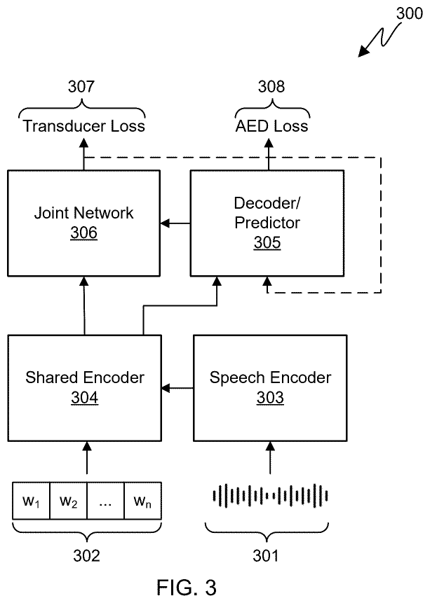

FIG. 3 illustrates an example framework 300 for a hybrid transducer and attention-based encoder-decoder in accordance with this disclosure. For case of explanation, the framework 300 of FIG. 3 is described as being implemented using the electronic device 101 and/or the server 106 in the network configuration 100 of FIG. 1. However, the framework 300 may be implemented using any other suitable device(s) and in any other suitable system(s).

As shown in FIG. 3, the framework 300 includes inputs for receiving audio speech input 301 and corresponding text input 302. For example, during training, paired speech input 301 and corresponding text input 302 may be obtained by having scripted text read (such as by each of a plurality of speakers) in order to obtain speech-to-text transcription for impromptu speech that has been checked for accuracy and completeness. Note, however, that training data may be obtained in any other suitable manner. During inferencing, only speech input may be received.

A speech encoder 303 receives the speech input 301 and outputs a sequence of vectors representing acoustic features and contextual information of the speech input 301. A shared encoder 304 receives both the output of the speech encoder 303 and the text input 302 corresponding to the speech input 301. For example, correlated speech input 301 and text input 302 can be processed, where the speech encoder 303 operates on the speech input 301 and the shared encoder 304 operates on the output of the speech encoder 303 and the corresponding text input 302. The shared encoder 304 creates a unified consistent representation of both the speech input 301 and the text input 302 for use in training a hybrid transducer and attention-based encoder-decoder framework. Here, the framework 300 takes two different input modalities, namely the speech input 301 and the text input 302. The speech input 301 is processed consecutively with both the speech encoder 303 and the shared encoder 304, while the text input 302 is processed only with the shared encoder 304.

The shared encoder 304 outputs multi-modal embeddings corresponding to the received speech, which are conditioned by a predictor 305 based on the previous text prediction outputs. A joint network 306 combines vectors output by the shared encoder 304 (which represent speech information) and vectors output by the predictor 305 (which represent linguistic information) to produce combined representations. Here, the predictor 305 and the joint network 306 are the same for both the speech input 301 and the text input 302. The output of the joint network 306 is a probability distribution over a target vocabulary, which can include a blank token to handle alignments between speech frames for the speech input 301 and text tokens for the text input 302.

As a hybrid transducer and attention-based encoder-decoder, the framework 300 is optimized with a transducer loss 307 from the joint network 306 and an attention-based encoder-decoder loss 308 (cross-entropy loss) from the predictor 305. Based on the transducer loss 307, the framework 300 can be trained to reduce or minimize loss over all possible alignments between speech frames for the speech input 301 and text tokens for the text input 302 to calculate the probability of output text given the speech input 301. In some embodiments, both losses can be applied during training with either or both of the speech input 301 and the text input 302 instead of just the speech input.

In some embodiments, for domain adaptation between the two modalities, text transcripts from a target domain can be provided to and used to adapt the predictor 305 only. For example, text transcripts from the speech domain and the corresponding output of the predictor 305 can be used for learning in the text domain, while text transcripts from the text domain and the corresponding output of the predictor 305 can be used for learning in the speech domain. The shared encoder 304 and the joint network 306 may optionally be adapted for those purposes.

In the framework 300, the joint network 306 is a multi-modality model. That is, an encoder within the joint network 306 is separated into multiple sub-encoders, namely the speech encoder 303 and the shared encoder 304 as shown in FIG. 3. In some cases, the speech encoder 303 can be based on a conformer encoder (a convolution-augmented transformer) and can be dedicated to the speech input 301. In some embodiments, the speech encoder 303 can include a down-sampling module to reduce the speech input frames (such as by a factor of four), followed by a module with stacked conformer layers. By contrast, in some cases, the shared encoder 304 may be assembled with transformer layers. The parameters in the shared encoder 304 and the predictor 305 can be shared by both the speech and text modalities. One motivation to switch, in the shared encoder 304, from conformer layers as used in the speech encoder 303 to transformer layers is to reduce modality discrepancies.

Compared with transformer layers, conformer layers can have an extra convolution module designed to model localized information. However, the resolution of the speech input 301 is different from the resolution of the corresponding text input 302 associated with the speech input 301. For example, the average sequence length of the speech input 301, after down-sampling, to the shared encoder 304 may be two to four times longer than the corresponding phoneme sequence length of the text input 302. The difference in resolutions could interfere with fusion of the modality information within convolution modules. On the other hand, a self-attention module in transformer or conformer layer can exchange information among input tokens via similarity and may therefore be less sensitive to different modalities and resolutions. As a result, an encoder that includes conformer layers followed by transformer layers can achieve similar or improved performance as a conformer encoder with fewer parameters. In some embodiments, self-attention with relative position embedding can be used in both conformer and transformer layers of the framework 300. Dedicated relative position embeddings for speech and text modalities may be employed, but parameters in self-attention modules can be shared among the different modalities.

In some embodiments, for fusion decoding with a hybrid transducer and attention-based encoder-decoder, two tasks can be optimized, choosing either the attention-based encoder-decoder decoding or the transducer decoding for inferencing. The transducer may adopt time-synchronized decoding and may be less impacted by hallucination issues, while the attention-based encoder-decoder may leverage audio information since all encoder outputs can be accessed. Thus, multiple decodings from the transducer and the attention-based encoder-decoder may be fused to enhance decoding accuracy. In some cases, the fusion may be defined as follows.

$$log p ( t , {y}_{i} \vert {x}_{s} , {y}_{1 : i - 1} ) = ( 1 - μ ) log {p}_{TR} ( t , {y}_{i} \vert {x}_{s} , {y}_{1 : i - 1} ) + μ log {p}_{AED} ( t , {y}_{i} \vert {x}_{s} , {y}_{1 : i - 1} )$$

Here, yᵢ represents a non-blank token, p_{TR} represents a prediction probability from a transducer decoding output, p_{AED} represents a prediction probability from an attention-based encoder-decoder output, and μ represents a weighting factor. Probabilities of blank tokens from the transducer may not be changed.

For ASR adaptation with text data, a joint (or hybrid) transducer and attention-based encoder-decoder can generate unified representations for speech and text modalities, making text-based adaptation possible. In some cases, different approaches may be used to conduct ASR adaptation with target domain text data instead of speech input. For example, in a “full decoder” approach, parameters in the decoder (the predictor 305) are updated, while parameters in other modules (the encoders 303, 304 and joint network 306) are kept intact. After that, the adapted model is used for decoding target domain speech using the transducer, using the attention-based encoder-decoder, or using fusion decoding as described above.

As another example, in a “partial decoder” approach, parameters in the main decoder base are frozen in addition to those parameters frozen in the “full decoder” approach. The main decoder base includes the input embedding and transformer layers, meaning only layers after the last decoder transformer layer are updated. One advantage here is that there is no parameter change for the transducer and attention-based encoder-decoder decoding, which may be used for general-purpose tasks. The target domain is enhanced via attention-based encoder-decoder decoding or fusion decoding. In some cases, an extra linear layer with layer normalization may be inserted between the last decoder transformer layer and the output embedding in the decoder to boost performance.

Although FIG. 3 illustrates one example of a framework 300 for a hybrid transducer and attention-based encoder-decoder, various changes may be made to FIG. 3. For example, while depicted separately, any combination of the transducer loss 307 and the attention-based encoder-decoder loss 308 may be used in different domains. As one particular example, only the attention-based encoder-decoder loss 308 may be used for optimization based on the text input 302, while both losses 307 and 308 may be used for optimization based on the speech input 301. Also, each function or component in FIG. 3 may be implemented in any other suitable manner. For instance, a recurrent neural network (RNN), such as a long short-term memory (LSTM), may be used for the predictor 305 rather than a transformer. In addition, in some embodiments, low-rank adaptation (LoRa) may be used for the domain adaptation of the decoder, instead of conducting adaptation on the entire decoder or output layers of the decoder.

Among other things, this disclosure enables building a strong ASR model with both text and speech input modalities, which can be used in various applications (including for low-resource languages) with both text and speech input modalities. Text data can be very useful to augment training data, and using target domain text data for domain adaptation can improve recognition accuracy. Also, joint modality training can effectively integrate speech and linguistic information into one model. Compared with a TAED baseline trained with speech data only, a jointly-trained system can reduce the word error rate (WER) significantly (in some cases on the order of 5-10% or even more) relative to an existing dataset. When evaluated on an out-of-domain speech dataset, a WER reduction of up to 20% or more may be achieved with the help of text-based domain adaptation.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
generating speech embeddings corresponding to a received speech input using a speech encoder;
generating multi-modal embeddings corresponding to the received speech input using a shared encoder;
generating conditioned multi-modal embeddings corresponding to the received speech input using a predictor; and
generating a text prediction corresponding to the received speech input based on the multi-modal embeddings and the conditioned multi-modal embeddings using a joint network.

2. The method of claim 1, wherein the text prediction is generated by a machine learning model.

3. The method of claim 2, wherein the machine learning model is trained using a loss function including a transducer loss from the joint network and an attention-based encoder-decoder loss from the predictor.

4. The method of claim 2, wherein the machine learning model is trained to perform in a first domain and is adapted to perform in a second domain by training the predictor using a training dataset with text data and no speech data.

5. The method of claim 4, wherein the machine learning model is trained to perform in the first domain by training the predictor using a training dataset with speech data and text data.

6. The method of claim 2, wherein the machine learning model comprises a hybrid transducer and attention-based encoder-decoder.

7. The method of claim 1, wherein:
the speech encoder comprises conformer layers;
the shared encoder comprises transformer layers; and
self-attention with relative position embedding is used in both the conformer layers and the transformer layers.

8. An electronic device comprising:
at least one processing device configured to:
generate speech embeddings corresponding to a received speech input using a speech encoder;
generate multi-modal embeddings corresponding to the received speech input using a shared encoder;
generate conditioned multi-modal embeddings corresponding to the received speech input using a predictor; and
generate a text prediction corresponding to the received speech input based on the multi-modal embeddings and the conditioned multi-modal embeddings using a joint network.

9. The electronic device of claim 8, wherein the at least one processing device is configured to generate the text prediction using a machine learning model.

10. The electronic device of claim 9, wherein the machine learning model is trained using a loss function including a transducer loss from the joint network and an attention-based encoder-decoder loss from the predictor.

11. The electronic device of claim 9, wherein the machine learning model is trained to perform in a first domain and is adapted to perform in a second domain by training the predictor using a training dataset with text data and no speech data.

12. The electronic device of claim 11, wherein the machine learning model is trained to perform in the first domain by training the predictor using a training dataset with speech data and text data.

13. The electronic device of claim 9, wherein the machine learning model comprises a hybrid transducer and attention-based encoder-decoder.

14. The electronic device of claim 8, wherein:
the speech encoder comprises conformer layers;
the shared encoder comprises transformer layers; and
self-attention with relative position embedding is used in both the conformer layers and the transformer layers.

15. A non-transitory machine readable medium containing instructions that when executed cause at least one processor of an electronic device to:
generate speech embeddings corresponding to a received speech input using a speech encoder;
generate multi-modal embeddings corresponding to the received speech input using a shared encoder;
generate conditioned multi-modal embeddings corresponding to the received speech input using a predictor; and
generate a text prediction corresponding to the received speech input based on the multi-modal embeddings and the conditioned multi-modal embeddings using a joint network.

16. The non-transitory machine readable medium of claim 15, wherein the instructions when executed cause the at least one processor to generate the text prediction using a machine learning model.

17. The non-transitory machine readable medium of claim 16, wherein the machine learning model is trained using a loss function including a transducer loss from the joint network and an attention-based encoder-decoder loss from the predictor.

18. The non-transitory machine readable medium of claim 16, wherein the machine learning model is trained to perform in a first domain and is adapted to perform in a second domain by training the predictor using a training dataset with text data and no speech data.

19. The non-transitory machine readable medium of claim 18, wherein the machine learning model is trained to perform in the first domain by training the predictor using a training dataset with speech data and text data.

20. The non-transitory machine readable medium of claim 16, wherein the machine learning model comprises a hybrid transducer and attention-based encoder-decoder.
